(19) United States
(12) Patent Application Publication
(10) Pub. No.: US 2018/0133109 A1
(43) Pub. Date: May 17, 2018

(54) TOOTHBRUSH HEAD STORAGE UNIT WITH PILL DISPENSER

(71) Applicant: Laurie Smith, Inglewood, CA (US)

(72) Inventor: Laurie Smith, Inglewood, CA (US)

(21) Appl. No.: 15/354,800

(22) Filed: Nov. 17, 2016

(51) Int. Cl. A61J 7/04; A46B 9/04; A46B 15/00; A61J 1/03; B65D 73/00; B65D 75/36; B65D 25/20

(52) U.S. Cl. CPC A61J 7/04; A46B 9/04; A46B 15/0095; A46B 2200/1066; B65D 73/0014; B65D 75/36; B65D 25/20; A61J 1/035

(57) ABSTRACT

A toothbrush head storage unit with pill dispenser. The apparatus includes a sleeve for holding a packet of pills, a container to receive the head of a toothbrush composed of two shells, the two shells hinged together on a first side and secured together by a latch on the second side. The container to receive the head of a toothbrush is attached to the sleeve holding a packet of pills.

### TECHNICAL FIELD OF THE DISCLOSURE

The present teachings relate to pill dispensing device. More particularly, the present teachings relate to pill dispensing device attached to a toothbrush head storage unit.

### BACKGROUND

Medications often require administration in a series of doses at specific time intervals. For example, some medications require daily administration, such as birth control pills. A frequent problem in medication timing is that a patient often cannot remember the last time medication was administered. Patients may forget a dose, thinking that they have already taken their medication, or double dose. Patients are often prompted to take medication to relieve certain symptoms, such as pain or cough. The same cannot be said for medications that are taken on specific intervals that are not to treat symptoms, such as birth control pills.

One way to remind patients to take their medication on a daily regimen is to couple the administration of their medication with habits already ingrained into the person's daily life, such as brushing one's teeth. By coupling a person's daily ritual of brushing their teeth with the administration of daily medication, such as birth control pills, every time the person brushes her teeth, she is given a visual and tactile reminder to take her birth control pill.

Though there are prior art devices that combine the act of brushing one's teeth with taking medication, such as Rai (U.S. Pat. No. 6,129,241), Panyon, Jr. (U.S. Pat. No. 5,755,020), and Proia (U.S. Pat. No. 4,140,140), the prior art devices require that the patient buy special toothbrushes. Moreover, the prior art devices all incorporate the pill dispenser into the handle of the toothbrush and thus are limited in the size and shape of pills that may be used in conjunction with such devices.

In view of the above limitations in the field, there currently exists a need in the industry for a simple, inexpensive and universal device that can combine the act of brushing one's teeth and administering medication.

All patents, patent applications, and non-patent references disclosed throughout the entirety of this application are hereby incorporated by reference for all purposes in their entireties.

### SUMMARY OF THE INVENTION

The present invention provides for a toothbrush head storage unit with an attached pill dispenser. This invention is an improvement of prior art devices that remind a patient to take their daily medications, such as birth control pills, with their daily habit of brushing his or her teeth. The present invention allows for a patient to use the toothbrush head storage unit having a pill dispenser with any toothbrush and any type of pills. The present invention is not limited to use with just a specific type of toothbrush or limited in the size and shape of the medication to be administered.

The present invention may also function as a toothbrush and medication travelling kit, which will help patients from forgetting to pack their medication when travelling. When the patient is packing to travel, the patient only has to remember to pack her toothbrush as the pills in the pill dispensing device will be packed with her toothbrush.

In one embodiment, the apparatus may include an enclosure composed of one shell for holding the head of a toothbrush, with an aperture adapted to allow the head of the toothbrush to be inserted and removed. The aperture is also adapted to allow the handle of toothbrush to protrude when the head of the toothbrush is inserted into the enclosure. The enclosure may be attached to a side of a sleeve that is adapted to hold a packet of pills.

In one embodiment, the apparatus may include an enclosure composed of two shells for holding the head of a toothbrush, with an aperture adapted to allow the handle of toothbrush to protrude. The enclosure may be attached to a side of a sleeve that is adapted to hold a packet of pills. The enclosure may be attached to a side of a sleeve adapted to hold pills, wherein the sleeve is comprised of the bubble packet of pills itself.

In yet another embodiment, the enclosure for holding the head of the toothbrush may be composed of a single shell with an aperture adapted to allow the handle of a toothbrush to protrude. The enclosure for holding the head of the toothbrush is affixed to a side of the sleeve wherein said side of the sleeve forms a part of the enclosure for holding the head of the toothbrush.

The enclosure for holding the head of a toothbrush may be removably attached to the side of the sleeve adapted to hold pills, whereby a user may detach the sleeve from the enclosure after administration of the pills and reattach the enclosure to a new sleeve holding new packet of pills. The removable attachment may achieved by such methods as use of Velcro attachment or clamps.

In another embodiment, the apparatus may include an enclosure composed of one shell for holding the head of a toothbrush, with an aperture adapted to allow the head of the toothbrush to be inserted and removed. The aperture is also adapted to allow the handle of toothbrush to protrude when the head of the toothbrush is inserted into the enclosure. The enclosure may be attached to a side of a sleeve that is adapted to hold a packet of pills.

In still another embodiment, the apparatus may include an enclosure composed of one shell for holding the head of a toothbrush, with an aperture adapted to allow the head of the toothbrush to be inserted and removed. The aperture is also adapted to allow the handle of toothbrush to protrude when the head of the toothbrush is inserted into the enclosure. The enclosure is attached to the side of a container with a top opening adapted for holding pills. The container may include a top capable of covering the top opening.

In another embodiment, the enclosure for holding the head of the toothbrush may be composed of two shells adapted to hold a head of the toothbrush, with an aperture to allow the handle of the toothbrush to protrude. The enclosure is attached to the side of a container with a top opening adapted for holding pills. The container may include a top capable of covering the top opening.

In yet another embodiment, the enclosure for holding the head of the toothbrush may be composed of one shell adapted to hold a head of toothbrush, with an aperture to allow the handle of the toothbrush to protrude. The enclosure is attached to a side of a container, wherein the side of the container forms part of the enclosure for holding the head of a toothbrush.

The enclosure for holding the head of a toothbrush may be removably attached to the side of the container adapted to hold pills, whereby a user may detach the container from the enclosure after administration of the pills and reattach the enclosure to a new sleeve holding new container of pills. The removable attachment may achieved by such methods as use of Velcro attachment.

In another embodiment, the apparatus may include an enclosure composed of one shell for holding the head of a toothbrush, with an aperture adapted to allow the head of the toothbrush to be inserted and removed. The aperture is also adapted to allow the handle of toothbrush to protrude when the head of the toothbrush is inserted into the enclosure. The enclosure is attached to the side of a container with a top opening adapted for holding pills. The container may include a top capable of covering the top opening.

### BRIEF DESCRIPTION OF THE DRAWINGS

The present teaching may be better understood by reference to the following detailed description taken in connection with the following illustrations:

FIG. 1 is a perspective view of the toothbrush head storage unit with pill dispenser, the enclosure formed of two shells;

FIG. 2 is a perspective view of the toothbrush head storage unit with pill dispenser with the toothbrush head storage unit in the open position;

FIG. 3 is a right side view of the toothbrush head storage unit with pill dispenser;

FIG. 4 is a left side view of the toothbrush head storage unit with pill dispenser;

FIG. 5 is a perspective view of an alternate embodiment of toothbrush head storage unit with pill dispenser;

FIG. 6 is a perspective view of an alternate embodiment of toothbrush head storage unit with pill dispenser with the toothbrush head storage unit in the open position;

FIG. 7 is a right side view of an alternate embodiment of the toothbrush head storage unit with pill dispenser;

FIG. 8 is a left side view of an alternate embodiment of the toothbrush head storage unit with pill dispenser;

FIG. 9 is a perspective view of another alternate embodiment of the toothbrush head storage unit with pill dispenser;

FIG. 10 is a perspective view of another alternate embodiment of the toothbrush head storage unit with pill dispenser with the toothbrush head storage unit in the open position;

FIG. 11 is a perspective view of alternate embodiment of the toothbrush head storage unit with pill dispenser with the toothbrush head storage unit;

FIG. 12 is a perspective view of alternate embodiment of the toothbrush head storage unit with pill dispenser with the toothbrush head storage unit in the open position; and

FIG. 13 is a perspective view of an alternate embodiment of the toothbrush head storage unit with pill dispenser with the toothbrush head storage unit detached from the sleeve to show a removable attachment.

FIG. 14 is a front view of an alternate embodiment of the toothbrush head storage unit with pill dispenser in the form of a sleeve with the enclosure for holding a head of a toothbrush composed of one shell with an aperture to allow the head of the toothbrush to be inserted and removed and to allow the handle of the toothbrush to protrude.

FIG. 15 is a front view of an alternate embodiment of the toothbrush head storage unit with pill dispenser shown in FIG. 14 with a cross-sectional view of the enclosure for holding a head of a toothbrush composed of one shell with an aperture to allow the head of the toothbrush to be inserted and removed and to allow the handle of the toothbrush to protrude.

FIG. 16 is a front view of an alternate embodiment of the toothbrush head storage unit with pill dispenser in the form of a container with the enclosure for holding a head of the toothbrush composed of one shell with an aperture to allow the head of the toothbrush to be inserted and removed and to allow the handle of the toothbrush to protrude.

FIG. 17 is a front view of an alternate embodiment of the toothbrush head storage unit with pill dispenser shown in FIG. 16 with a cross-sectional view of the enclosure for holding a head of the toothbrush composed of one shell with an aperture to allow the head of the toothbrush to be inserted and removed and to allow the handle of the toothbrush to protrude.

### DETAILED DESCRIPTION OF EMBODIMENTS

The following description is made for the purpose of illustrating the general principles of the invention and should not be taken in a limiting sense. The scope of the invention is best determined by reference to the appended claims.

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein.

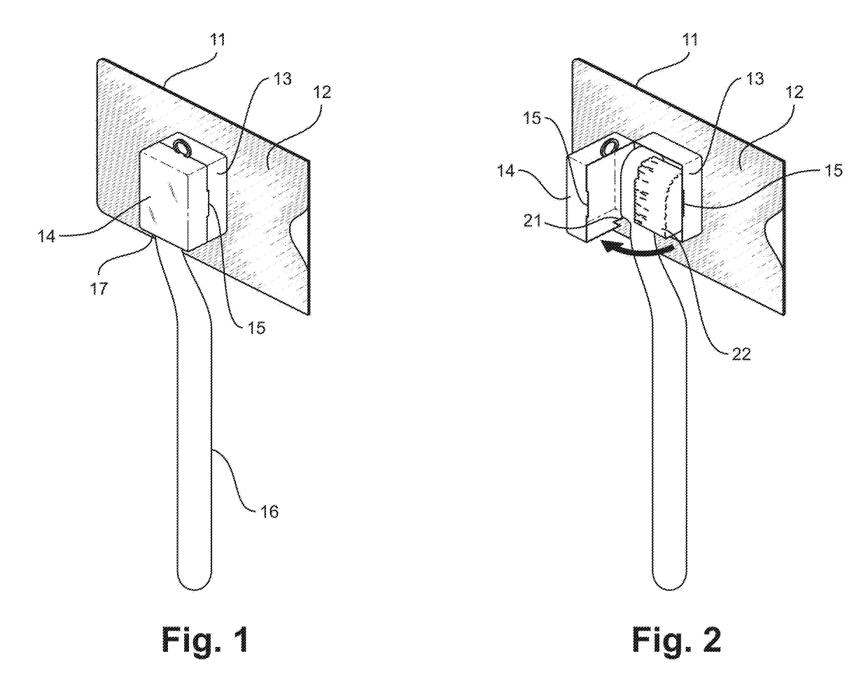

Turning to the figures, FIG. 1 is a perspective view of the toothbrush head storage unit with pill dispenser. The apparatus includes a sleeve 11 adapted for holding packets of pills. The apparatus includes an enclosure 17 for receiving the head of a toothbrush 22 (FIG. 2). The sleeve 11 may be composed of flexible material adapted to holding different size packet of pills. The enclosure 17 may be comprised of two shells 13 and 14, which may be in the close position (FIG. 1) when the toothbrush is not in use, or may be in the open position (FIG. 2) to release the head of the toothbrush 22. The first shell 13 may be attached to a side of the sleeve 12. The two shells 13 and 14 may be secured together by a latch 15 on a first side of the enclosure. The enclosure 17 includes an aperture 21, which allows for the handle of the toothbrush 16 to protrude from the enclosure 17.

Though the two shells 13 and 14 of the enclosure are shown in the figures to form a rectangular shape, the two shells 13 and 14 may be formed in different shapes, such as clam shells, semicircles or other shapes adapted for receiving the head of a toothbrush.

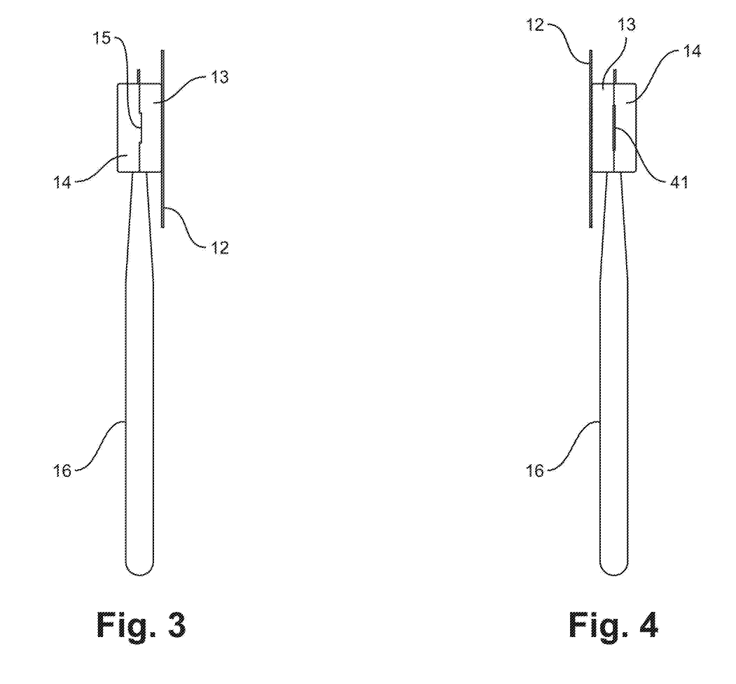

FIGS. 3-4 are side views of the toothbrush head storage unit with pill dispenser. The enclosure 17 may include a hinge 41 on a second side of the enclosure. The enclosure 17 may be opened by releasing the latch 15 and the two shells 13 and 14 are rotated about hinge 41.

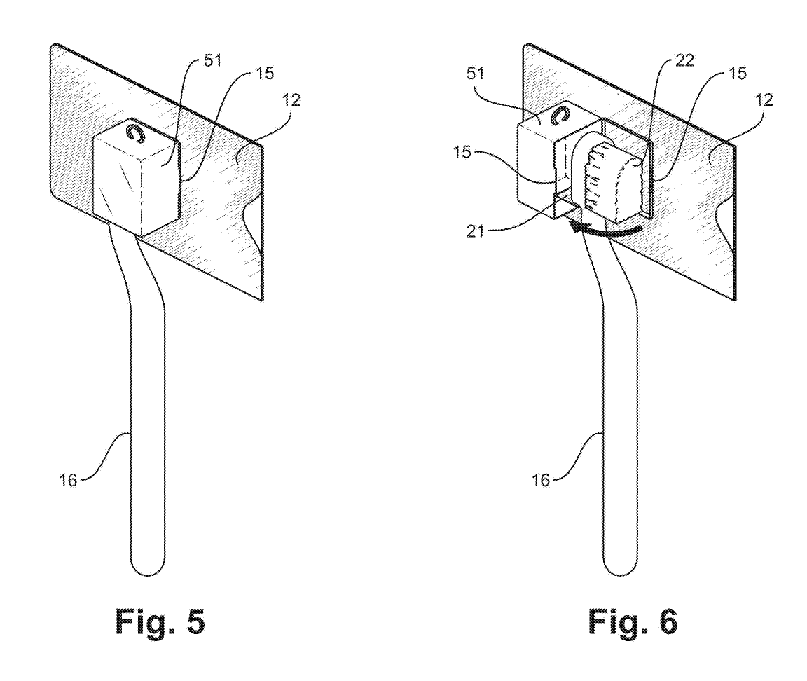

FIGS. 5-6 are perspective views of the toothbrush head storage unit with pills dispenser. The enclosure for receiving the head of the toothbrush may be comprised of one shell 51. A side of the sleeve 12 forms part of the enclosure 17 for receiving the head of a toothbrush. Half of a latch 15 is attached to the side of the sleeve 12 and the other half of the latch 12 is part of the shell 51.

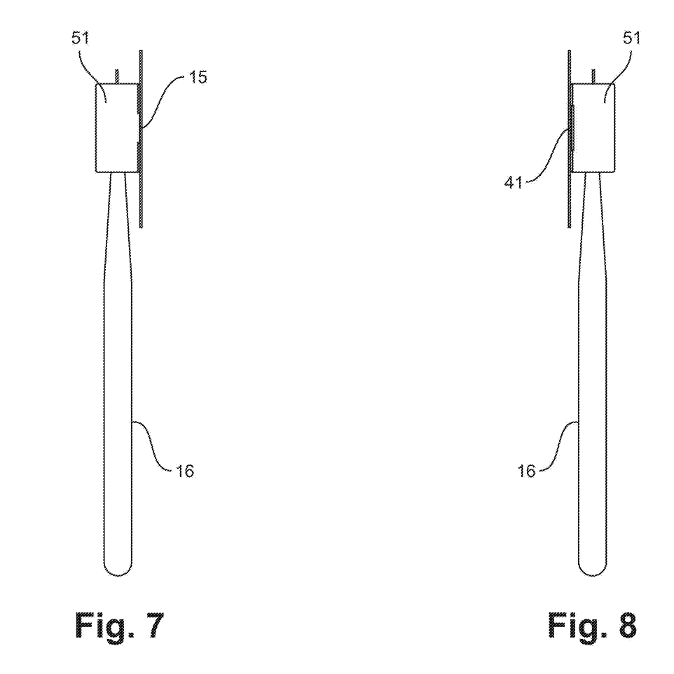

FIGS. 7-8 are side views of the alternate embodiment of the toothbrush head storage unit with pill dispenser. The hinge 41 is attached to a side of the sleeve 12 and the shell 51. One half of the latch 15 is part of the shell 51 and the enclosure 17 is secured in the closed position with the other half of the latch 15 attached to the side of the sleeve 12.

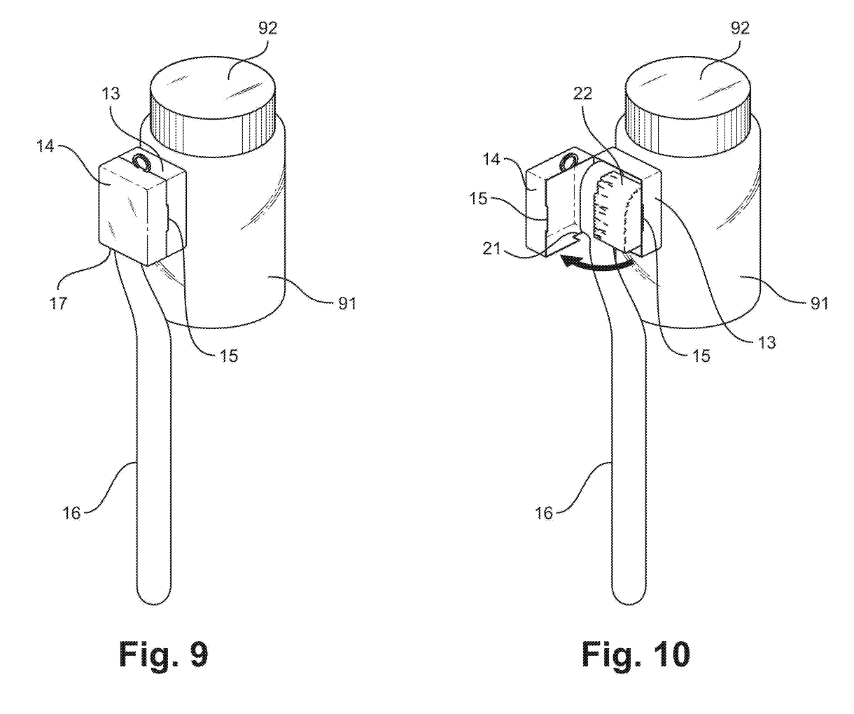

FIGS. 9-10 are perspective view of an alternate embodiment of the toothbrush head storage unit with pill dispenser. The enclosure 17 is attached to a container 91 adapted for holding pills. The container 91 includes a top opening (not shown) that may be closed by a cap 92. The cap 92 may be removed from the container 91 to access the pills in container 91 for administration of the medication, i.e. birth control pills, or to refill the container 91 with pills when necessary.

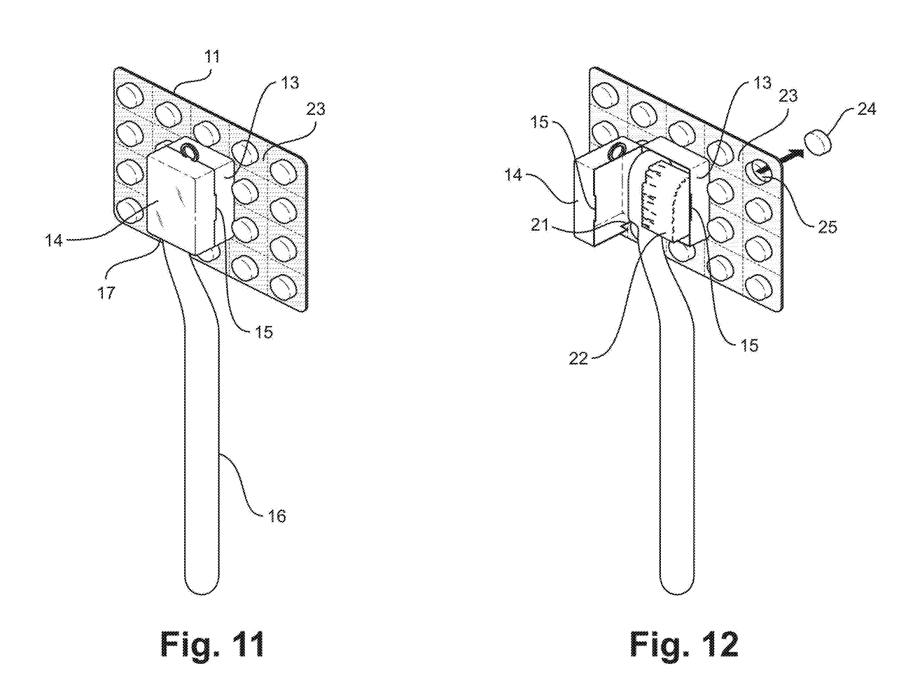

FIGS. 11-12 are perspective view of an alternate embodiment of the toothbrush head storage unit with pill dispenser. The enclosure 17 is attached to a sleeve 11, wherein the bubble packet of pills 23 itself is the sleeve. The pill 24 can be released from the sleeve by pressing on the bubble portion 25 of the bubble packet of pills 23.

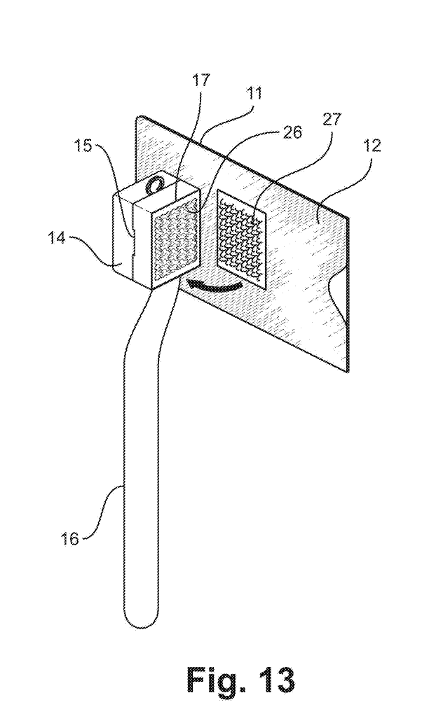

FIG. 13 is a perspective view of an alternate embodiment of the invention wherein the enclosure is removably attached to sleeve 11 and can be detached from the sleeve after administration of the pills. The toothbrush head storage unit can be removably attached to the sleeve 11, for example by way of Velcro attachments 26 and 27. After administration of the pills, a user can detach the enclosure 17 and attach the enclosure 17 to a side of new sleeve 12 holding a new packet of pills.

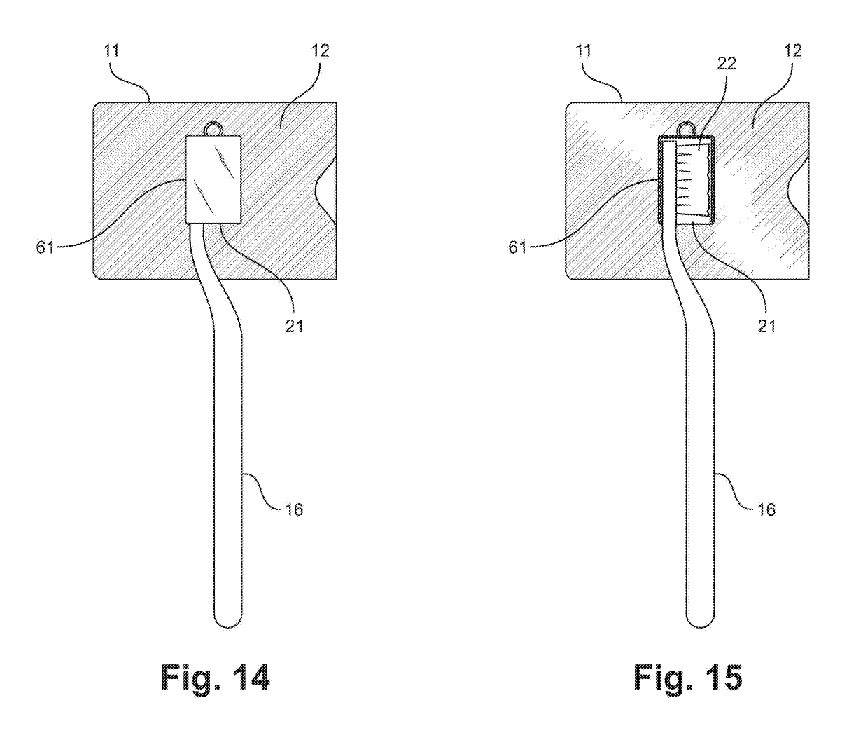

FIG. 14 is a front view of an alternate embodiment of the invention with the enclosure 61 for holding the head of a toothbrush 22, wherein the enclosure 61 is composed of one shell. FIG. 15 is a front view of the same alternate embodiment of the invention with a cross sectional view of the enclosure 61. The aperture 21 is adapted to allow the head of the toothbrush 22 to be inserted and remove. The aperture 21 is also adapted to allow the handle of the toothbrush 16 to protrude when the head of the toothbrush 22 is inserted into the enclosure 61. A side of the enclosure 61 is attached to a side 12 of the sleeve 11.

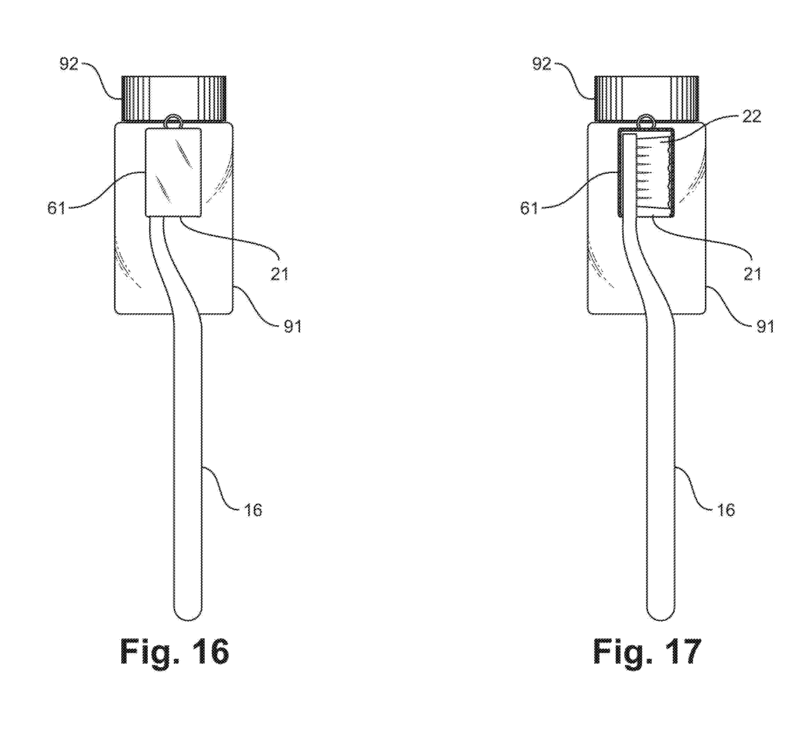

FIG. 16 is a front view of an alternate embodiment of the invention with a enclosure 61 for holding the head of a toothbrush 22, wherein the enclosure 61 for holding the head of a toothbrush 22 is composed of one shell. FIG. 17 is a front view of the same alternate embodiment of the invention with a cross sectional view of the enclosure 61. The aperture 21 is adapted to allow the head of the toothbrush 22 to be inserted and remove. The aperture 21 is also adapted to allow the handle of the toothbrush 16 to protrude when the head of the toothbrush 22 is inserted into the enclosure 61. The enclosure 61 is attached to a side of the container 91.

The foregoing description of the embodiments of the present invention has been presented for the purpose of illustration and description. It is not intended to be exhaustive or to limit the invention to the precise form disclosed. Many modifications and variations are possible in light of the above teachings. The numerical values described in the description are only for illustration purpose and should not be understood as limiting the invention to the precise numbers. It is intended that the scope of the present invention not be limited by this detailed description, but by the claims and the equivalents to the claims appended hereto.

I claim:

1. The pill dispensing device comprising:
a sleeve having an opening in which the sleeve is adapted for holding packets of pills, said sleeve having at least one side;
an enclosure for receiving a toothbrush head of a toothbrush, said enclosure having at least one side, the enclosure having an aperture adapted to permit a toothbrush handle to protrude;
said side of enclosure affixed to said side of said sleeve; and,
whereby a user is reminded to take a pill every time the toothbrush is used.

2. The pill dispensing device in claim 1, wherein:
said enclosure having two shells, the shells hinged together on a first side, a latch on a second side for securing the shells together.

3. The pill dispensing device in claim 1, wherein:
said sleeve is flexible whereby said flexible sleeve is adapted for holding packets of pills of different sizes.

4. The pill dispensing device in claim 1, wherein:
said enclosure is removably affixed to said side of said sleeve.

5. The pill dispensing device in claim 1, wherein:
said enclosure having one shell, the shell hinged together on a first side to said side of said sleeve, a latch on a second side for securing the shell to said side of said sleeve.

6. The pill dispensing device comprising:
a container having a top opening adapted for holding pills and said container having at least one side;
an enclosure for receiving a toothbrush head of a toothbrush, said enclosure having at least one side, the enclosure having an aperture adapted to permit a toothbrush handle to protrude;
said side of said enclosure affixed to said side of said container; and
whereby a user is reminded to take a pill every time the toothbrush is used.

7. The pill dispensing device in claim 6, further comprising:
said enclosure having two shells, the shells hinged together on a first side, a latch on a second side for securing the shells together.

8. The pill dispensing device in claim 6, further comprising:
a cap capable of covering said top opening of said container.

9. The pill dispensing device in claim 6, wherein:
said enclosure is removably affixed to said side of said container.
